(19) United States
(12) Patent Application Publication
(10) Pub. No.: US 2026/0179174 A1
(43) Pub. Date: Jun. 25, 2026

(54) EFFICIENT PROCESSING OF OPACITY MICRO-MAPS

(71) Applicant: Advanced Micro Devices, Inc., Santa Clara, CA (US)

(72) Inventors: Won Jong Lee, Santa Clara, CA (US); Michael John Livesley, Cambridge (GB); Ian Richard Beaumont, Sydney (AU); David Kirk McAllister, Santa Clara, CA (US)

(73) Assignee: Advanced Micro Devices, Inc., Santa Clara, CA (US)

(21) Appl. No.: 18/990,059

(22) Filed: Dec. 20, 2024

(51) Int. Cl. G06T 1/60; G06T 15/06

(52) U.S. Cl. CPC G06T 1/60; G06T 15/06; G06T 2200/04

(57) ABSTRACT

A feature referred to as “opacity micro-maps” provides an efficient representation of geometric detail for ray tracing primitives. One issue with opacity micro-maps is that in a highly parallel system with many rays referencing nearby opacity micro-map data in parallel, a great deal of unnecessary memory traffic may be generated. To combat this unnecessary memory traffic, a mechanism is provided herein for reducing the number of redundant memory requests. According to this mechanism, opacity micro-map circuitry maintains an indication of pending memory requests for opacity micro-map data. If a new request for opacity micro-map evaluation occurs and the data required for that new request is at the same address as the pending memory request, then no additional memory request is generated for the new request. When the data from the pending memory request is returned from memory, that data is used to satisfy all evaluation requests that are outstanding.

### BACKGROUND

In image synthesis, ray tracing is utilized to find a nearest intersection of a given ray with a scene where light propagation is simulated.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 is an illustration of opacity micro-maps, according to an example;

FIG. 6 is a block diagram of a system for performing ray tracing operations, according to an example;

FIGS. 7-9 illustrate operations that occur for servicing opacity micro-map requests; and

FIG. 10 is a flow diagram of a method for performing opacity micro-map operations, according to an example.

### DETAILED DESCRIPTION

Ray tracing is a rendering technique whereby rays are cast into a scene and pixels of a render target are colored based on which objects the rays intersect. To speed such operations up, a ray tracing system typically builds an acceleration structure such as a bounding volume hierarchy (“BVH”). Such a structure has a hierarchy of levels, where each level can include nodes. Each non-leaf node has references to other nodes as well as a bounding volume that encloses the geometry of those other nodes. When traversing the BVH, the ray is tested for intersection with such bounding volumes and traversal to the nodes referenced does not occur if the ray does not intersect the bounding volumes. Leaf nodes include references to primitives. Depending on the result of an intersection test between a ray and a primitive, the ray tracing pipeline causes shader work to be performed.

A feature referred to as “opacity micro-maps” provides fine-grained detail for individual primitives. More specifically, a texture that is mapped to a primitive indicates whether various subdivisions of the primitive are opaque, non-opaque, or “unknown.” When the ray tracing pipeline determines that a ray intersects with a subdivision of primitive having an associated opacity micro-map, the opacity micro-map circuitry reads the opacity micro-map data to determine whether that intersection should be treated as a “hit,” a “miss,” or whether that intersection should be evaluated by an any-hit shader to determine whether a hit or miss occurs. An opacity micro-map thus indicates whether each of a plurality of subdivisions of a primitive are opaque, non-opaque, or “unknown” according to a bitmask. Further, the data for such maps is represented in a compact format (e.g., a bitmask).

One issue with opacity micro-maps is that in a highly parallel system with many rays referencing nearby opacity micro-map data in parallel, a great deal of unnecessary memory traffic may be generated. In an example, a single memory request to fetch the opacity micro-map data can result in data for many primitive subdivisions being read in. In such an example, if each ray results in such a memory request being generated, then many such memory requests would be redundant.

To combat this unnecessary memory traffic, a mechanism is provided herein for reducing the number of redundant memory requests. According to this mechanism, opacity micro-map circuitry maintains an indication of pending memory requests for opacity micro-map data. If a new request for opacity micro-map evaluation occurs and the data required for that new request is at the same address as the pending memory request, then no additional memory request is generated for the new request for opacity micro-map evaluation. When the data from the pending memory request is returned from memory, that data is used to satisfy all evaluation requests that are outstanding.

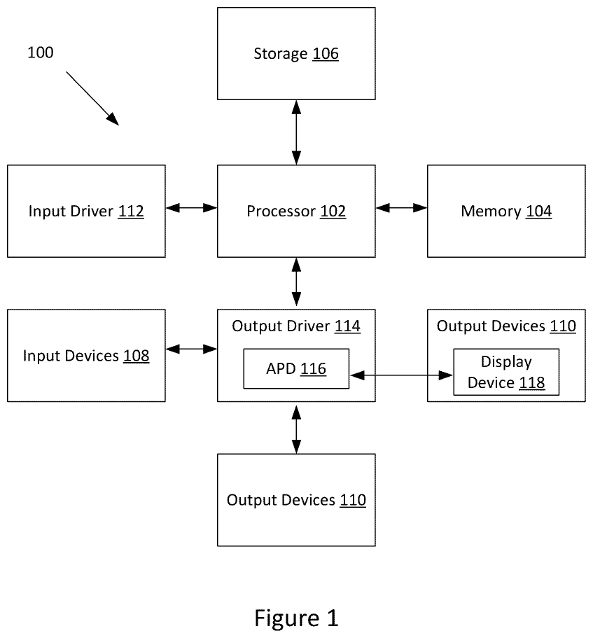

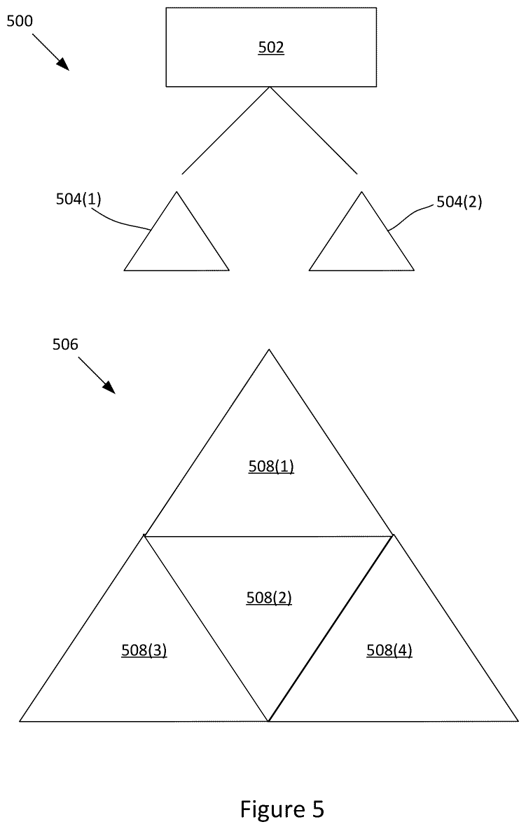

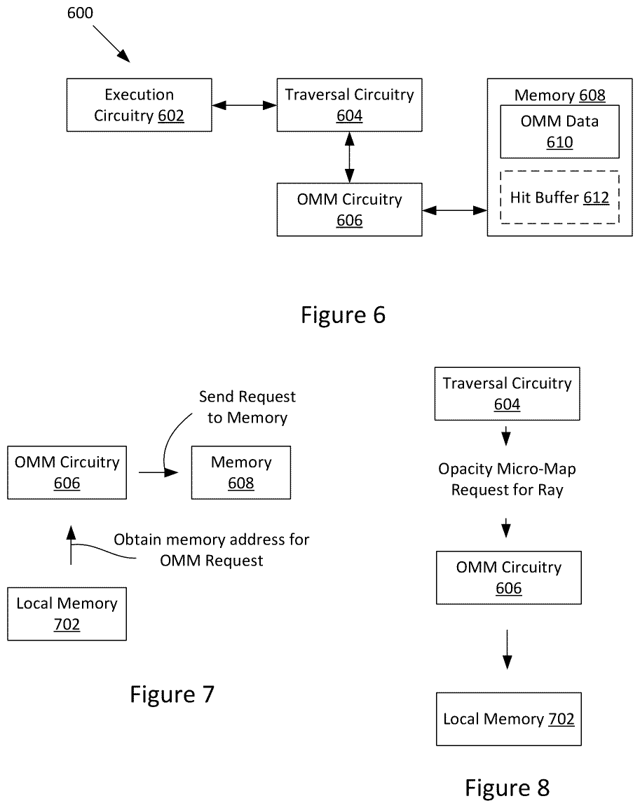

In the present disclosure, FIGS. 1-4 provide background for ray tracing. FIG. 5 illustrates an opacity micro-map. FIG. 6 is a block diagram of a system for performing ray tracing operations. FIGS. 7-9 illustrate operations for servicing opacity micro-map requests. FIG. 10 is a flow diagram of a method for performing opacity micro-map operations.

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a parallel processing paradigm, such as a single-instruction-multiple-data (“SIMD”) paradigm or a single-instruction-multiple-threads (“SIMT”). Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a parallel processing paradigm may perform the functionality described herein. Alternatively, it is contemplated that computing systems that do not perform processing tasks in accordance with a parallel processing paradigm can also perform the functionality described herein.

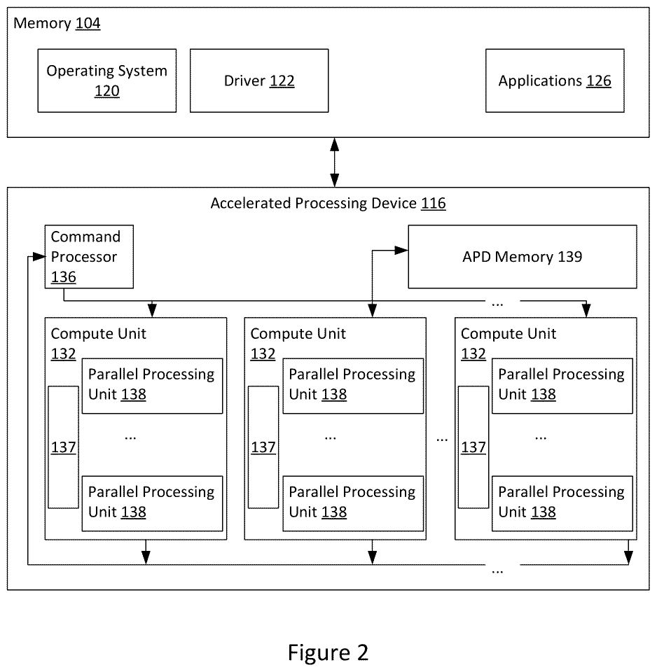

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow. An APD memory 139 serves as global memory for the compute units 132, which also have internal local data shares 137 that serve as local memory.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps. One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A command processor 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

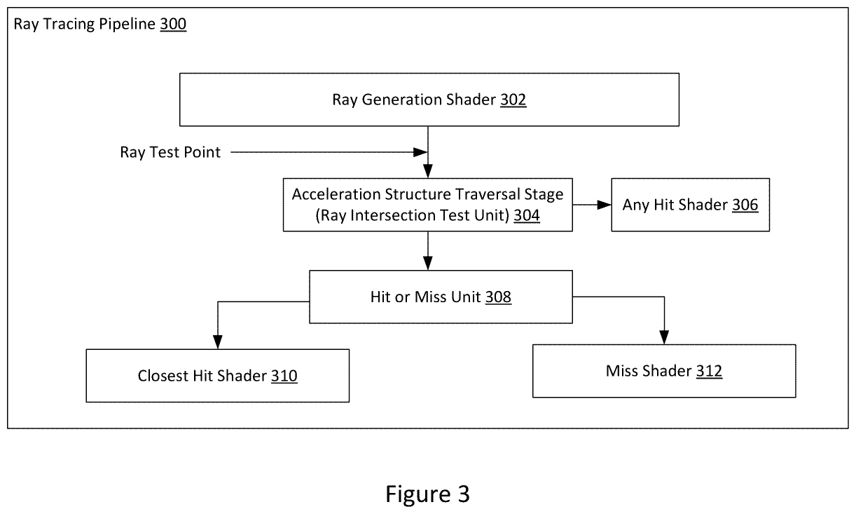

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the command processor 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For non-opaque triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

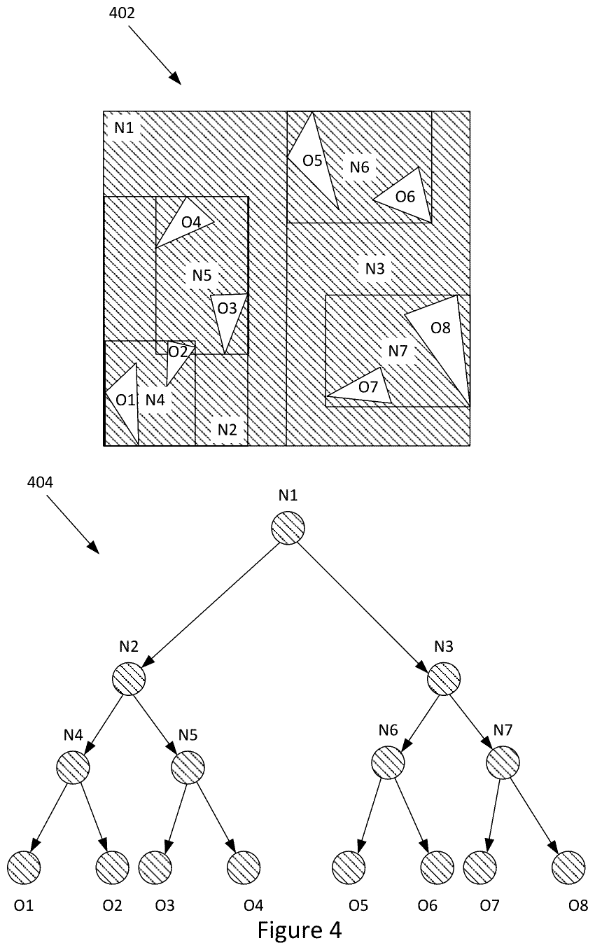

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

FIG. 5 is an illustration of opacity micro-maps, according to an example. As stated elsewhere herein, leaf nodes of a BVH include indications of primitives such as triangles. It is possible to have finely detailed geometry simply by increasing the number of such primitives in an object. However, a more efficient technique referred to as opacity micro-maps can be used in certain situations. In general, an opacity micro-map is a set of information that indicates which geometric subdivisions of a primitive are considered opaque and which not opaque (e.g., transparent). In some examples, opacity micro-maps include an indication of an implicit subdivision geometry that indicates how the primitives are subdivided into portions that map to the opacity micro-map. In addition, the opacity micro-map indicates which of the subdivisions are opaque, which not opaque (“transparent”), which are “unknown transparent” and which are “unknown opaque,” where “unknown transparent” and “unknown opaque” are collectively referred to as “unknown” and mean that an any hit shader needs to determine whether a hit has occurred, or the intersection hardware can be told to make a decision regarding whether to interpret these as “opaque” or “transparent.” More particularly, the any hit shader is only invoked for the “unknown” cases and for the other, no any hit shader is performed. For the “transparent” case, a hit is never determined to occur. For the “opaque” case, the closest hit shader is directly invoked if it is determined that the hit is the closest such hit. For the “unknown” cases, the any hit shader is invoked to determine whether to identify such an occurrence as a hit or a miss.

In FIG. 5, a portion of a BVH 500 is illustrated. The BVH 500 includes a node 502 that includes indications of two primitives 504. The first primitive 504(1) has an associated opacity micro-map 506. The opacity micro-map has four regions that map to the primitive as shown. In addition, the opacity micro-map indicates which subdivision 508 is opaque and which is not opaque. In summary, this configuration efficiently provides a mechanism to determine the opacity of a region within the primitive.

In an example, traversal, for a ray, of a BVH having a primitive with an associated opacity micro-map occurs in the following manner. The ray tracing pipeline 300 traverses to a primitive that has an opacity micro-map. As a result, the ray tracing pipeline 300 identifies which portion of the opacity micro-map the ray hits (e.g., identifies which subdivision 508 the ray hits), and fetches the opacity micro-map data for that primitive. The ray tracing pipeline 300 evaluates the fetched micro-map data and proceeds according to that evaluation. In an example, the micro-map data indicates that the corresponding subdivision 508 is unknown (e.g., unknown opaque or unknown transparent). Thus, the ray tracing pipeline 300 executes an any hit shader for that ray to evaluate whether a hit actually occurs. Continuing the example, for a different ray that intersects the same triangle, the subdivision 508 intersected by that ray is indicated as transparent or opaque according to the opacity micro-map. As a result, the ray tracing pipeline 300 would not execute an any hit shader for that intersection.

One important issue related to opacity micro-maps is that in a highly parallelized system, accessing such maps for multiple rays being processed in parallel can lead to a high amount of memory pressure. In an example, multiple rays executing in parallel are directed at nearby but distinct locations within a scene. In such an example, each such ray might trigger its own memory transaction in order to fetch the appropriate opacity micro-map data (e.g., an indication of whether the intersected subdivision 508 is opaque or transparent).

In some examples, many such rays all intersect the same primitive and thus require opacity micro-map data from that primitive. Even if the rays do not intersect the same subdivision 508 (and thus do not require the same exact item of opacity micro-map data), a memory request to obtain data for one ray may necessarily bring in data for one or more other rays. For example if the indication for each subdivision 508 is two bits, then because memory loads do not have two bit resolution (e.g., much more than two bits are loaded per memory load), indications for multiple subdivisions 508 would be loaded per request for such data. Moreover, if multiple rays, each requiring opacity indications that are different but close together in memory, each generated a separate memory request, this activity could be considered to be redundant and thus inefficient. It is also possible for different primitives to refer to the same opacity micro-map. For at least this reason, techniques are provided herein to more efficiently load opacity micro-map data.

FIG. 6 is a block diagram of a system 600 for performing ray tracing operations, according to an example. The system 600 includes execution circuitry 602, traversal circuitry 604, opacity micro-map circuitry (“OMM circuitry”) 606, and memory 608. Each of the execution circuitry 602, the traversal circuitry 604, and the OMM circuitry 606 is embodied as electrical circuitry configured to perform the operations described herein. In various examples, this circuitry is located within the parallel processing units 138 of the APD 116. In some examples, the memory 608 is a general purpose memory of the APD 116 or even the memory 104.

The execution circuitry 602 includes execution pipeline hardware for executing instructions of shader programs. Such shader programs include instructions that perform ray tracing operations. These operations include generation of rays, execution of shader operations (e.g., any-hit, closest hit, miss shaders, or other operations) to determine attributes of pixels for a rendered image, or any other operations involved in ray tracing. The traversal circuitry 604 is hardware that traverses a BVH for a ray at the request of the execution circuitry 602. More specifically, the execution circuitry 602 executes shader instructions to perform ray tracing operations. Such operations include generating a ray and requesting traversal of the BVH for the ray. This request is sent to the traversal circuitry 604 for execution. This traversal traverses the BVH for the ray, determining which nodes of the BVH are intersected. For nodes that are intersected and that require shader work, the traversal circuitry 604 “returns” indications to the execution circuitry 602 that such shader work is to be performed. The traversal circuitry 604 may continue traversal of the BVH for the same ray even if such shader work is required. In an example, an any hit shader is to be executed when the traversal circuitry 604 identifies a “candidate” hit for a ray and a primitive (e.g., where the opacity micro-map information indicates that the corresponding subdivision has an “unknown” opacity). Thus, the traversal circuitry 604 requests the execution circuitry 602 to perform such any hit shader work. Because this shader is executed for any non-opaque intersection of a ray with a primitive, a single traversal through a BVH for a single ray may result in multiple any hit shader invocations. Thus, while and/or after the above any hit shader work occurs in the execution circuitry 602, the traversal circuitry 604 continues traversal of the BVH to determine if additional work is to be performed.

As described above, the traversal circuitry 604 traverses a BVH for a ray. This traversal includes, among other things, determining whether the ray intersects with a primitive. If the primitive has an associated opacity micro-map, then the traversal circuitry 604 requests the opacity micro-map circuitry 606 to determine whether the ray hits or misses the primitive, or requires an invocation of an any hit shader to make such a determination (e.g., determines whether the candidate hit is accepted, rejected, or whether an any hit shader invocation is required to determine whether to accept or reject that candidate hit). To make this determination, the opacity micro-map circuitry 606 identifies the subdivision 508 of the primitive that is potentially hit by the ray, calculates an address for the opacity information for that subdivision 508, and transmits a request for that opacity information to the memory 608. The memory 608 provides that information from the opacity micro-map data 610 back to the opacity micro-map circuitry 606, which then determines whether the information indicates that the ray accepts, or rejects the candidate hit for the subdivision, or whether to invoke an any hit shader to make such a determination (e.g., due to the subdivision 508 being opaque, transparent, or unknown).

As stated above, it is possible for multiple rays to require information from the opacity micro-map data 610 at the same or nearly the same time. With a “naive” technique, the OMM circuitry 606 sends at least one request to the memory 608 for OMM data 610 for each ray needing such data, even if multiple such rays need data from the same address. However, as described above, this would lead to inefficiencies.

Thus the OMM circuitry 606 performs operations to reduce the number of memory transactions that are performed for OMM data 610. More specifically, when the traversal circuitry 604 sends an OMM request to the OMM circuitry 606, if there are outstanding memory requests made by the OMM circuitry, the OMM circuitry tracks the received OMM request in a queue to be processed at a later time. An “OMM request” is a request for evaluation for OMM data for a particular subdivision 508 of a primitive. At any point in time, the OMM circuitry 606 may be waiting for a return from memory 608 of OMM data 610 for one or more OMM requests. When such data is returned from the memory 608, the OMM circuitry 606 checks the tracked OMM requests to see which such OMM request the returned data applies to. The OMM circuitry 606 processes any such tracked OMM request using the returned data and does not send any other memory requests for OMM data for such processed requests. In other words, instead of sending one memory request per ray that needs OMM data, the OMM circuitry 606 sends one memory request per combination of rays needing OMM data at the same address (e.g., the same cache line address).

In an example, the traversal circuitry 604 determines that a first ray intersects a primitive that has opacity micro-map data. In response, the traversal circuitry 604 requests evaluation of that opacity micro-map data by the OMM circuitry 606. The OMM circuitry 606 transmits a request to the memory 608 for the required OMM data 610 and stores an indication of the first ray as well as what data is being retrieved (e.g., the offset within the cache line) for the first ray. Then, the traversal circuitry 604 determines that a second ray intersects a primitive that has opacity micro-map data that is considered to be at the same cache line address as the opacity micro-map data of the first ray. (A cache line address is an address of a cache line, which is typically a chunk of data larger than the amount accessed by a typical instruction such as a load instruction. A cache line is also the amount of data that is typically read into a cache or evicted from a cache.). In response, the traversal circuitry 604 requests evaluation of that opacity micro-map data by the OMM circuitry 606. Based on the fact that a memory request for the same address is already outstanding, the OMM circuitry 606 does not send a request to the memory 608 for the OMM data for the second ray. Subsequently, when the opacity micro-map data for the first ray is returned, the OMM circuitry 606 uses this data to determine opacity for both the first ray and the second ray, and provides results of this evaluation to the traversal circuitry 604 for both rays. In some examples, this evaluation includes determining whether the opacity micro-map data indicates that the corresponding subdivision 508 is opaque, transparent, or unknown. The traversal circuitry 604 uses this information to determine whether to request the execution circuitry 602 perform subsequent work (e.g., an any hit shader) and/or determines what work to perform (e.g., which any hit shader to execute).

The above description provides a mechanism to avoid duplicate memory requests for opacity micro-map data for different rays to the same address. In an example, a first memory request and a second memory request for opacity micro map data are “to the same address” if making either memory request would result in loading opacity micro-map data for the other request. In an example, both requests are to a different items of opacity micro-map data that are within the same unit of memory loaded from memory (e.g., a byte or a word). In an example, both requests are to the same cache line, but to a different item of micro-map data within that cache line. In such an example, the OMM circuitry 606 has access to a cache. The OMM circuitry 606 examines the cache to find micro-map data when a request arrives from the traversal circuitry 604. If such data is not in the cache, then the OMM circuitry 606 requests such data to be fetched from the memory 608. In some examples, the smallest amount of data that can be fetched from a memory 608 into a cache is a cache line, which is an amount of consecutive bytes (e.g., 128 bytes) in memory. If a memory request for a first ray fetches a cache line that includes opacity micro-map data for a first ray and opacity micro-map data is also needed for a second ray, and if that opacity micro-map data is within the same cache line, then the OMM circuitry 606 does not transmit a request to the memory 608 to fetch data for the second ray, as that data is already or will soon be in the cache and available to the OMM circuitry 606. In this example, requests “to the same address” are requests to data in the same cache line.

In some examples, upon receiving a request for OMM evaluation from the traversal circuitry 604, the OMM circuitry 606 stores an indication of that request in a memory in order to track that request. In some examples, the memory is a queue including a set of slots. Each slot stores an indication for one ray, where the indication includes information such as a ray identifier, a primitive identifier, a subdivision 508 identifier, and an offset within a cache line of the required OMM data. In some examples, such a local memory has a limited amount of space. In some examples, in the event that the OMM circuitry 606 receives a request for OMM evaluation from the traversal circuitry 604 and there are no free slots in the memory, the OMM circuitry 606 does not store an indication for that request. Instead, the ray that generated that request is suspended from further traversal of the BVH in the traversal circuitry 604 and the request for OMM evaluation is discarded. The OMM circuitry 606 maintains a ray suspension indication for each ray that is suspended in this manner. When a slot in the local memory becomes free, the OMM circuitry 606 causes the traversal circuitry 604 to regenerate the request for OMM evaluation. In the event that a memory request for the data for that request is outstanding when the request is regenerated, the OMM circuitry 606 places an indication for that request in the slot that became free. Subsequently, when the memory request is returned, the OMM circuitry 606 evaluates the OMM data for that request (e.g., determines whether the data indicates a hit or a miss) and returns the evaluation to the traversal circuitry 604 for further evaluation (e.g., determination of what work is to be subsequently performed, such as whether an any hit shader is to be executed).

The operation of discarding and regenerating the request is beneficial in that it prevents stalling of the execution circuitry 602 and traversal circuitry 604. More specifically, one possible technique for handling the situation in which there is no free space in the local memory of the OMM circuitry 606 to store an indication for an OMM evaluation request is to pause operations (stall) in the traversal circuitry 604 until such a slot becomes available. However, this is a heavyweight response to such a condition. Discarding and then regenerating the request allows other operations to proceed while waiting for space in such a local memory to become available.

In some examples a hit buffer 612 is present in the memory 608. The hit buffer 612 allows speculative execution. More specifically, the hit buffer 612 stores indications of intersections of a ray with a non-opaque primitive created by the traversal circuitry 604. In response to the traversal circuitry 604 determining that a ray intersects a primitive with corresponding opacity micro-map data, the OMM circuitry 606 stores an indication of that intersection into the hit buffer 612. The OMM circuitry 606 processes such indications (e.g., determines whether the corresponding opacity micro-map data indicates a hit or a miss) and returns such information to the traversal circuitry 604. The hit buffer 612 acts as a buffer of previously identified intersections that require evaluation by the OMM circuitry 606 or any hit shader (for example). Storing such indications in the hit buffer 612 allows the traversal circuitry 604 to continue traversing the BVH for a ray even in the event that an intersection has one or more OMM evaluations outstanding. Stated differently, in some examples, the traversal circuitry 604 identifies an intersection of a ray with a primitive that requires OMM evaluation (e.g., determination of whether the OMM data 610 indicates that the corresponding subdivision 508 is transparent, opaque, or unknown). In some examples, the traversal circuitry 604 does not wait for such evaluation to complete before proceeding with additional traversal of the BVH. The OMM circuitry 606 places requests to perform OMM evaluation into the hit buffer 612 and processes those requests in due course. The OMM circuitry 606 returns the results of such evaluation to the traversal circuitry 604, which performs appropriate actions (e.g., if an evaluation indicates that a ray is evaluated as “unknown,” then the traversal circuitry 604 causes an any hit shader to execute for that ray and that primitive subdivision 508). Traversal of the BVH even with one or more items of OMM evaluation outstanding is considered “speculative execution.”

FIGS. 7-9 illustrate operations that occur for servicing opacity micro-map requests from the traversal circuitry 604. FIGS. 7-9 will be described in conjunction with FIG. 10, which illustrates these operations as a flow diagram. More specifically, FIG. 10 is a flow diagram of a method 1000 for performing opacity micro-map operations, according to an example. Although described with respect to the system of FIGS. 1-9, those of skill in the art will understand that any system configured to perform the steps of the method 1000 in any technically feasible order falls within the scope of the present disclosure.

At step 1002, (illustrated in FIG. 7), OMM circuitry 606 initiates a first OMM data memory request to a first address in the memory 608 for a first OMM evaluation request. In this example, an indication of the first OMM evaluation request is retrieved from the local memory 702 and was thus previously stored in the local memory. More specifically, prior to step 1002, the traversal circuitry 604 arrived at a primitive having a corresponding opacity micro-map. Thus the traversal circuitry 604 transmitted a request to the OMM circuitry 606 for OMM evaluation. The OMM circuitry 606 stored an indication of that request in the local memory 702. At a later time, coincident with step 1002, the OMM circuitry 606 obtains the address for the OMM data associated with this request and transmits a request to memory 608 to fetch that OMM data. In some examples, this transmission is triggered when data for a different request from the OMM circuitry 606 to memory 608 is returned. In other words, because a request for OMM data has been satisfied, capacity for requests between the OMM circuitry 606 and memory 608 has become available and thus the OMM circuitry 606 selects one of the request indications stored in the local memory 702 for processing (e.g., by obtaining appropriate OMM data from memory 608). More specifically, in some examples, the interface between the OMM circuitry 606 and the memory 608 has a memory request capacity that indicates how many memory requests are allowed to be outstanding between the OMM circuitry 606 and the memory 608 at any given time. In some examples, if there is no spare capacity, then the OMM circuitry 606 does not immediately make the request to obtain the OMM data 610 for the just-received OMM request, and makes such request when such capacity becomes available (e.g., due to data for a different request being returned from the memory 608).

At step 1004, the first OMM data memory request is pending - the memory 608 has not yet returned the requested OMM data. While this request is pending, the OMM circuitry 606 receives a second request for OMM evaluation. This second request is for a different ray than the first request, but is made “to the same address,” as described elsewhere herein (e.g., OMM data for the subdivision 508 of the first request and the second request are within the same unit of memory brought in when a read operation occurs—and such unit of memory can be a cache line or other amount of data). The OMM circuitry 606 stores an indication of this second request in the local memory 702. In FIG. 8, which illustrates operations of step 1004, it can be seen that the OMM circuitry 606 receives the opacity micro-map evaluation request for a ray from the traversal circuitry 604 and stores information for that request into the local memory 702. In the example of step 1004, the first OMM evaluation request and the second OMM evaluation request are directed to the same memory address, and a request for the OMM data at that address is currently pending. For this reason, the OMM circuitry 606 does not generate a memory request to the memory 608 for the second OMM evaluation request, as such a request would be redundant.

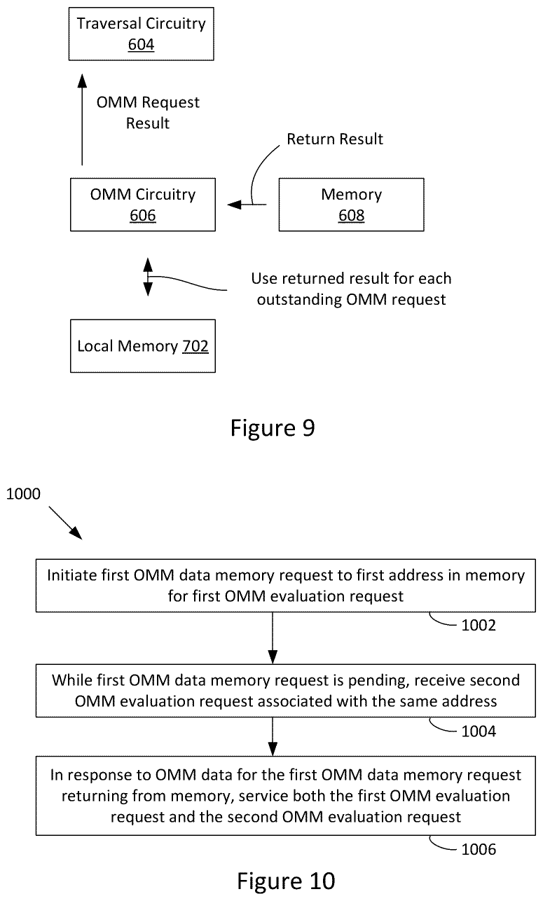

At step 1006, the memory 608 returns the data for the first OMM data memory request to the OMM circuitry 606. The OMM circuitry 606 examines the local memory 702 to determine which OMM evaluation requests are waiting for OMM data from that address. The OMM circuitry 606 determines that the first OMM evaluation request and the second OMM evaluation request are both waiting for that data and thus processes both of those requests with the data returned from memory 608 without generating a new memory request to memory 608 for either such OMM evaluation request. As can be seen, in FIG. 9, the memory 608 returns the requested result to the OMM circuitry 606, which uses that result for the outstanding OMM evaluation requests for that address. The OMM circuitry 606 processes such OMM evaluation requests (e.g., determining whether the returned data indicates that the corresponding subdivision is opaque or not opaque and thus whether a hit occurs or does not occur) and returns the results of such processing to the traversal circuitry 604. The traversal circuitry 604 continues with appropriate execution, such as triggering execution of an any hit shader if a ray is evaluated as “unknown” or not triggering execution of such a shader if the ray is not evaluated as “unknown.”

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the command processor 136, the compute units 132, the SIMD units 138, the ray tracing pipeline 300, including the ray generation shader 302, acceleration structure traversal stage 304, any hit shader 306, hit or miss unit 308, closest hit shader 310, or the miss shader 312, may be implemented as a general purpose computer, a processor, a processor core, or in digital circuitry or analog circuitry, or as a program, software, or firmware, stored in a non-transitory computer readable medium or in another medium, executable by a general purpose computer, a processor, or a processor core. The execution circuitry 602, traversal circuitry 604, and OMM circuitry 606 are described as “circuitry,” but could alternatively be implemented as programmable hardware, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
initiating a first data memory request to a first address in memory for a first opacity micro-map evaluation request for a first ray;
while the first data memory request is pending, receiving a second opacity micro-map evaluation request associated with the first address; and
in response to a first opacity micro-map data for the first opacity micro-map request being returned from the memory, servicing both the first opacity micro-map evaluation request and the second opacity micro-map evaluation request utilizing the first opacity micro-map data.

2. The method of claim 1, further comprising:
in response to the first data memory request being pending, refraining from issuing a memory request to the memory for the second opacity micro-map evaluation request.

3. The method of claim 2, wherein the refraining also occurs in response to the first opacity micro-map evaluation request and the second opacity micro-map evaluation request being directed to the first address.

4. The method of claim 1, wherein the first opacity micro-map evaluation request is for a first subdivision of a first primitive and the second opacity micro-map evaluation request is for a second subdivision of the first primitive or a second primitive.

5. The method of claim 1, further comprising storing an indication of the second opacity micro-map evaluation request in a local memory.

6. The method of claim 5, further comprising checking the local memory to determine that the first opacity micro-map evaluation request and the second opacity micro-map evaluation request are associated with the first opacity micro-map data.

7. The method of claim 5, further comprising:
receiving a subsequent opacity micro-map evaluation request; and
in response to the local memory being full, discarding the subsequent opacity micro-map evaluation request and suspending processing for a second ray associated with the subsequent opacity micro-map evaluation request.

8. The method of claim 7, further comprising:
regenerating the subsequent opacity micro-map evaluation request in response to a slot becoming available in the local memory.

9. The method of claim 1, further comprising performing speculative processing for the first ray by allocating an entry in a hit buffer for the first opacity micro-map evaluation request.

10. A system comprising:
a memory; and
an opacity micro-map circuitry configured to:
initiate a first data memory request to a first address in the memory for a first opacity micro-map evaluation request for a first ray;
while the first data memory request is pending, receiving a second opacity micro-map evaluation request associated with the first address; and
in response to a first opacity micro-map data for the first opacity micro-map request being returned from the memory, servicing both the first opacity micro-map evaluation request and the second opacity micro-map evaluation request utilizing the first opacity micro-map data.

11. The system of claim 10, wherein the opacity micro-map circuitry is further configured to:
in response to the first data memory request being pending, refrain from issuing a memory request to the memory for the second opacity micro-map evaluation request.

12. The system of claim 11, wherein the refraining also occurs in response to the first opacity micro-map evaluation request and the second opacity micro-map evaluation request being directed to the first address.

13. The system of claim 10, wherein the first opacity micro-map evaluation request is for a first subdivision of a first primitive and the second opacity micro-map evaluation request is for a second subdivision of the first primitive or a second primitive.

14. The system of claim 10, wherein the opacity micro-map circuitry is further configured to store an indication of the second opacity micro-map evaluation request in a local memory.

15. The system of claim 14, wherein the opacity micro-map circuitry is further configured to check the local memory to determine that the first opacity micro-map evaluation request and the second opacity micro-map evaluation request are associated with the first opacity micro-map data.

16. The system of claim 14, wherein the opacity micro-map circuitry is further configured to:
receive a subsequent opacity micro-map evaluation request; and
in response to the local memory being full, discard the subsequent opacity micro-map evaluation request and suspending processing for a second ray associated with the subsequent opacity micro-map evaluation request.

17. The system of claim 16, wherein the opacity micro-map circuitry is further configured to:
regenerate the subsequent opacity micro-map evaluation request in response to a slot becoming available in the local memory.

18. The system of claim 10, wherein the opacity micro-map circuitry is further configured to perform speculative processing for the first ray by allocating an entry in a hit buffer for the first opacity micro-map evaluation request.

19. A non-transitory computer-readable storage medium storing instructions that, when executed by a processor, cause the processor to perform operations comprising:
initiating a first data memory request to a first address in memory for a first opacity micro-map evaluation request for a first ray;
while the first data memory request is pending, receiving a second opacity micro-map evaluation request associated with the first address; and
in response to a first opacity micro-map data for the first opacity micro-map request being returned from the memory, servicing both the first opacity micro-map evaluation request and the second opacity micro-map evaluation request utilizing the first opacity micro-map data.

20. The non-transitory computer-readable medium of claim 19, wherein the instructions further cause the processor to:
in response to the first data memory request being pending, refrain from issuing a memory request to the memory for the second opacity micro-map evaluation request.
